(19) United States
(12) Patent Application Publication
(10) Pub. No.: US 2014/0172816 A1
(43) Pub. Date: Jun. 19, 2014

(54) SEARCH USER INTERFACE

(71) Applicant: KT Corporation, Seongnam-si (KR)

(72) Inventors: Ju-yong LEE, Incheon (KR); Donghyun JANG, Seoul (KR); Jong-an KIM, Gwacheon-si (KR); Jin-han KIM, Gunpo-si (KR)

(73) Assignee: KT Corporation, Seongnam-si (KR)

(21) Appl. No.: 14/107,122

(22) Filed: Dec. 16, 2013

(30) Foreign Application Priority Data
Dec. 14, 2012 (KR) 10-2012-0146449

(51) Int. Cl. G06F 17/30

(52) U.S. Cl. CPC G06F 17/30554
USPC 707/706; 707/722

(57) ABSTRACT

In one example embodiment, a system may include a device configured to: receive a first user input to identify at least a portion of video content at a point in the play time of the video content, transmit the identified portion of the video content to a text recognition server, receive, from the text recognition server, at least one word that is detected from the identified video content, display the at least one received word, receive a second user input to select one of the displayed at least one word, and transmit a request to search for information regarding the selected word; and the text recognition server configured to: receive, from the device, the identified portion of the video content, retrieve the at least one word displayed on the video content at the point in the play time of the video content, and transmit, to the device, the at least one word.

### TECHNICAL FIELD

The embodiments described herein pertain generally to a search user interface.

### BACKGROUND

As mobile communication systems become ubiquitous, mobile devices are increasingly employed as a user's primary search device.

### SUMMARY

In one example embodiment, a system may include a device configured to: receive a first user input to identify at least a portion of video content at a point in the play time of the video content, transmit the identified portion of the video content to a text recognition server, receive, from the text recognition server, at least one word that is detected from the identified video content, display the at least one received word, receive a second user input to select one of the displayed at least one word, and transmit a request to search for information regarding the selected word; and the text recognition server configured to: receive, from the device, the identified portion of the video content, retrieve the at least one word displayed on the video content at the point in the play time of the video content, and transmit, to the device, the at least one word.

In another example embodiment, there is a method in connection with a device having a user interface. The method may include receiving a first user input to video content that is played on at least the device; transmitting, to a text recognition server, an identified portion of the video content at a point in the play time of the video content; receiving, from the text recognition server, at least one word that is detected from the identified portion of the video content; displaying the at least one received word; receiving a second user input to select one of the displayed at least one word; and transmitting, to a search engine, a request to search for information regarding the selected word.

In yet another example embodiment, a device may include a user input receiver configured to receive a first user input to identify at least a portion of video content that is played on at least the device; a transmitter configured to transmit, to a text recognition server, the identified portion of the video content; a receiver configured to receive, from the text recognition server, at least one word that is detected from the identified portion of the video content; and a display unit configured to display the at least one received word. The user input receiver may be further configured to receive a second user input to selects one of the displayed at least one word. The transmitter may be further configured to transmit a request to search for information regarding the selected word.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which a search user interface (UI) may be implemented, in accordance with embodiments described herein;

FIGS. 2A and 2B show example search embodiments to implement at least portions of search, in accordance with embodiments described herein;

FIGS. 3A and 3B show an example processing flow of operations to implement at least portions of search by a search UI, in accordance with embodiments described herein;

FIG. 4 shows yet another example processing flow of operations to implement at least portions of search by a search UI, in accordance with embodiments described herein;

FIG. 5 shows yet another example system configuration in which a search UI may be utilized, in accordance with embodiments described herein;

FIG. 6 shows an example configuration of a device on which a search UI may be utilized, in accordance with embodiments described herein;

FIG. 7 shows still another example configuration of a device on which a search UI may be utilized, in accordance with embodiments described herein;

FIG. 8 shows an example configuration of a service request manager corresponding to a search UI, in accordance with embodiments described herein; and

FIG. 9 shows an illustrative computing embodiment, in which any of the processes and sub-processes of a search scheme using a search UI displayed on a device may be implemented as computer-readable instructions stored on a computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

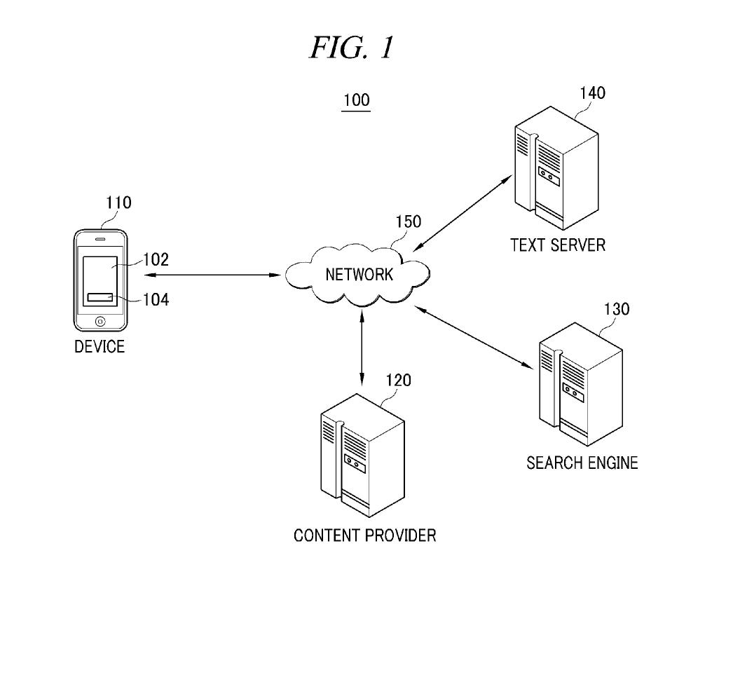

FIG. 1 shows an example system configuration 100 in which search UI 102 may be implemented, in accordance with embodiments described herein. As depicted in FIG. 1, system configuration 100 may include, at least, search UI 102 displayed or otherwise hosted on device 110, a content provider 120 (that is representative of a server operated by a content provider), a search engine 130, and a text recognition server 140. At least two or more of device 110, content provider 120, search engine 130 and text recognition server 140 may be communicatively connected to each other via a network 150. As referenced herein, search UI 102 may include a search box 104.

Device 110 may refer to a display apparatus configured to play various type of media content, such as television content, video on demand (VOD) content, music content, various other media content, etc., that may be received from content provider 120. The display apparatus may refer to at least one of an IPTV (internet protocol television), a DTV (digital television), a smart TV, a connected TV or a STB (set-top box), a mobile phone, a smart phone, a tablet computing device, a notebook computer, a personal computer or a personal communication terminal. Non-limiting examples of such display apparatuses may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Device 110 may configured to play video content that is received from content provider 120. On playing the video content, to search for information regarding a word that may be shown on a video frame of the video content, as either closed-captioning or as a depicted image, device 110 may be configured to connect to search engine 130 via a web browser.

Device 110 may be configured to host search UI 102 to search for information regarding a word that is detected from the video content. For example, when video content plays on device 110, search UI 102 may display at least one word that is shown on corresponding video frame of the video content by selecting, identifying, or highlighting at least a portion of the video content at a point in the play time of the video content. As referenced herein, the at least one word displayed on search UI 102 may be recognized by text recognition server 140 and received from text recognition server 140.

Then, upon clicking, selecting, or otherwise highlighting the word displayed on search UI 102, search UI 102 may display that word on search box 104, and display search results pertaining to the word. Further, the search results pertaining to the word may be received from search engine 130.

Search UI 102 may be hosted and executed on device 110 by installing an application that corresponds to search UI 102. By way of example, the application may be downloaded to device 110 from virtual application market, such as the Apple™ App Store, Google™ Play, etc.

Content provider 120 may refer to an Internet service provider (ISP); application service provider (ASP); storage service provider (SSP); and television service provider, i.e., cable TV, DSL and DBS, that may be configured to receive a request for the video content that may be selected by a user from device 110, and to further transmit the requested video content to device 110.

Further, content provider 120 may be configured to transmit the selected video content to text recognition server 140 from among multiple video content selections stored therein.

Search engine 130, hosted by one or more web portal providers, may be configured to receive a request to search for information regarding a selected or highlighted word received from device 110. Then, search engine 130 may search the Internet for information regarding the topic represented by the selected or highlighted word. As referenced herein, the search result may include, at least, web pages, images, information, and other types of files pertaining to the topic represented by the selected or highlighted word. Search engine 130 may transmit search results to device 110.

Text recognition server 140 may refer to either hardware or software that is configured to analyze a video frame to thereby recognize text or words associated with the video frame, and to further store the recognized words or text associated with the video frame. For example, text recognition server 140 may extract a plurality of frames from video content that are received from content provider 120, and recognize at least one recognized word associated with the respective frames. As referenced herein, the recognizing of the at least one word may be executed by utilizing an optical character reader (OCR) method.

Further, when text recognition server 140 receives, from device 110, an identified portion of video content at the point in the play time of the video content received, text recognition server 140 may retrieve the at least one word corresponding to the identified portion of the video content and transmit the at least one retrieve word to device 110.

As referenced herein, text recognition server 140 may be configured to pre-recognize the at least one word shown on the frame by using the OCR method, prior to receiving the identified portion of the video content. However, alternatively, text recognition server 140 may be configured to recognize the at least one word shown on the frame by using the OCR method when receiving the identified portion of the video content.

In some embodiments, text recognition server 140 may save a recognized word, and transmit the saved word to device 110. For example, a recognized and saved word or words, transmitted from text recognition server 140 to device 110, may exclude, for example, numbers, articles, helping verbs, etc. that may not be critical to understanding context of the recognized word or words. Further, text recognition server 140 may save a recognized noun in its singular form if a recognized word is a noun, and save a verb in its infinitive form if a recognized word is a verb.

Network 150, which may be configured to communicatively couple device 110, content provider 120, search engine 130 and text recognition server 140, may be implemented in accordance with any wireless network protocol, such as the Internet, a mobile radio communication network including at least one of a 3rd generation (3G) mobile telecommunications network, a 4th generation (4G) mobile telecommunications network, any other mobile telecommunications networks, WiBro (Wireless Broadband Internet), Mobile WiMAX, HSDPA (High Speed Downlink Packet Access) or the like. Alternatively, network 150 may include at least one of a near field communication (NFC), radio-frequency identification (RFID) or peer to peer (P2P) communication protocol.

Thus, FIG. 1 shows example system configuration 100 in which search UI 102 may be implemented, in accordance with embodiments described herein.

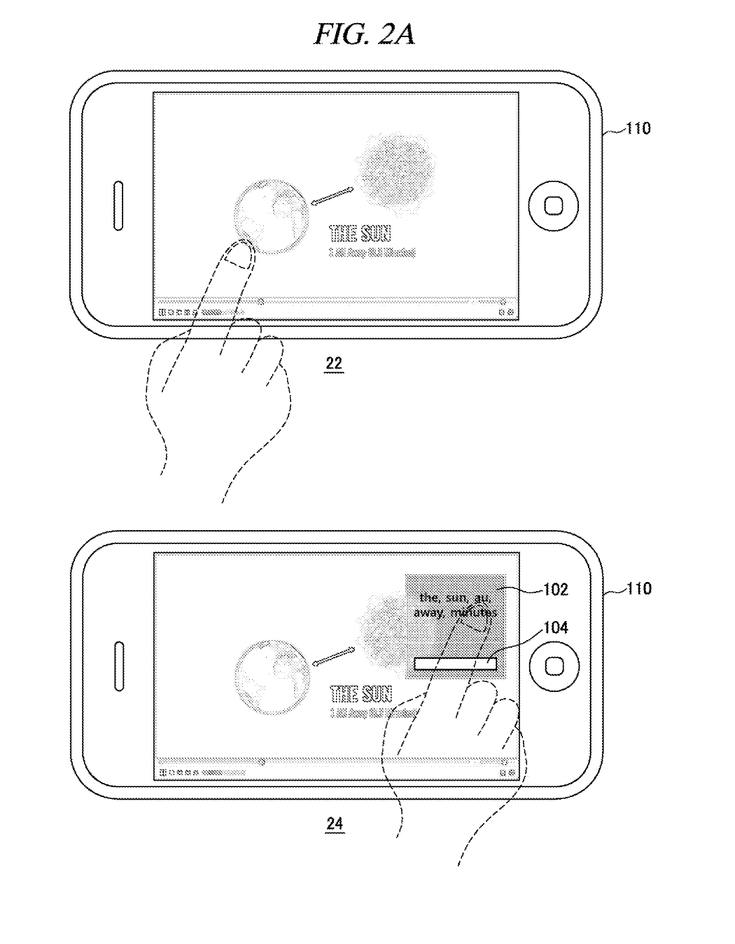

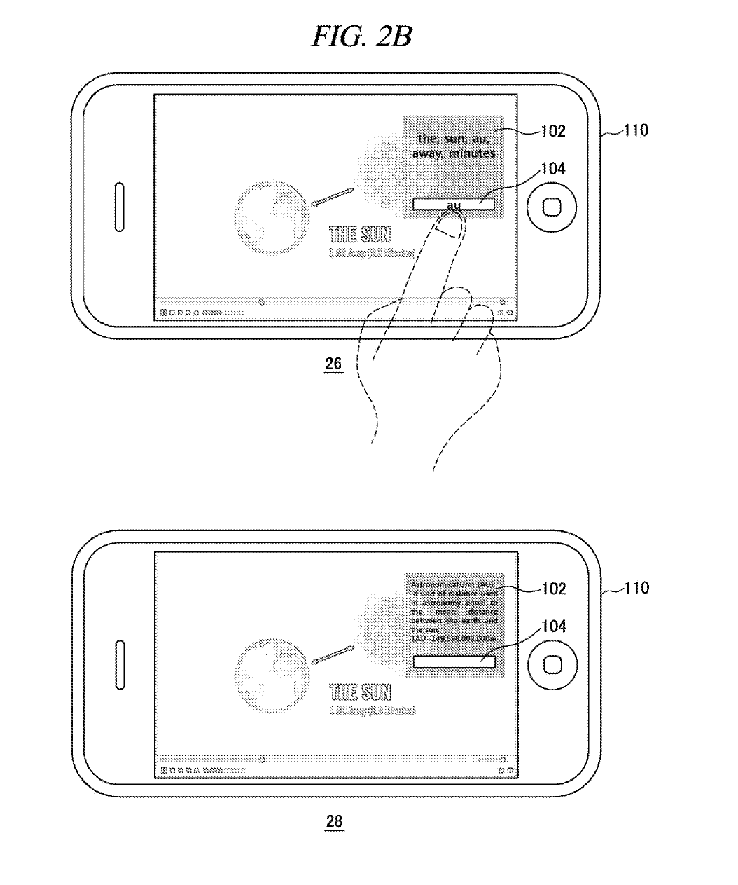

FIGS. 2A and 2B show example search embodiments to implement at least portions of search, in accordance with embodiments described herein.

As depicted in the example of FIG. 2A, search embodiment 22 may refer to device 110 playing video content on device 110 showing ‘THE SUN’, and ‘1 AU Away (8.3 Minutes)’. When device 110 receives a user input that clicks, selects, or otherwise highlights any point on a frame of the played video content, search embodiment 22 may be changed to search embodiment 24.

Search embodiment 24 may refer to device 110 displaying search UI 102 on the frame, and search UI 102 showing search box 104, and words ‘the’, ‘sun’, ‘au’, ‘away’, and ‘minutes’, which are shown the frame. When search UI 102 receives a user input that clicks, selects, or otherwise activates one word ‘au’, search embodiment 24 may be changed to search embodiment 26 in FIG. 2B.

As depicted in the example of FIG. 2B, search embodiment 26 may refer to search UI 102 displaying activated ‘au’ on search box 104. When search UI 102 receives a user input that clicks, selects, or otherwise activates search box 104 to search for information regarding ‘au’, search embodiment 26 may be changed to search embodiment 28.

Search embodiment 28 may refer to search UI 102 displaying the information regarding ‘au’ received from search engine 130.

Thus, FIGS. 2A and 2B show example search embodiments to implement at least portions of search, in accordance with embodiments described herein.

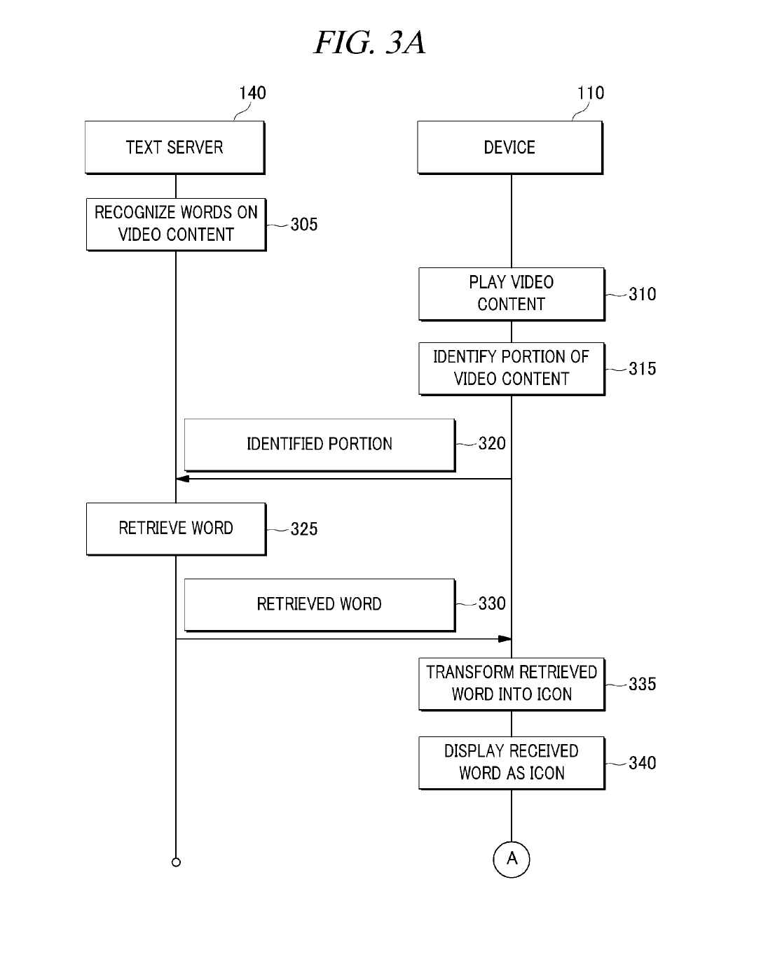

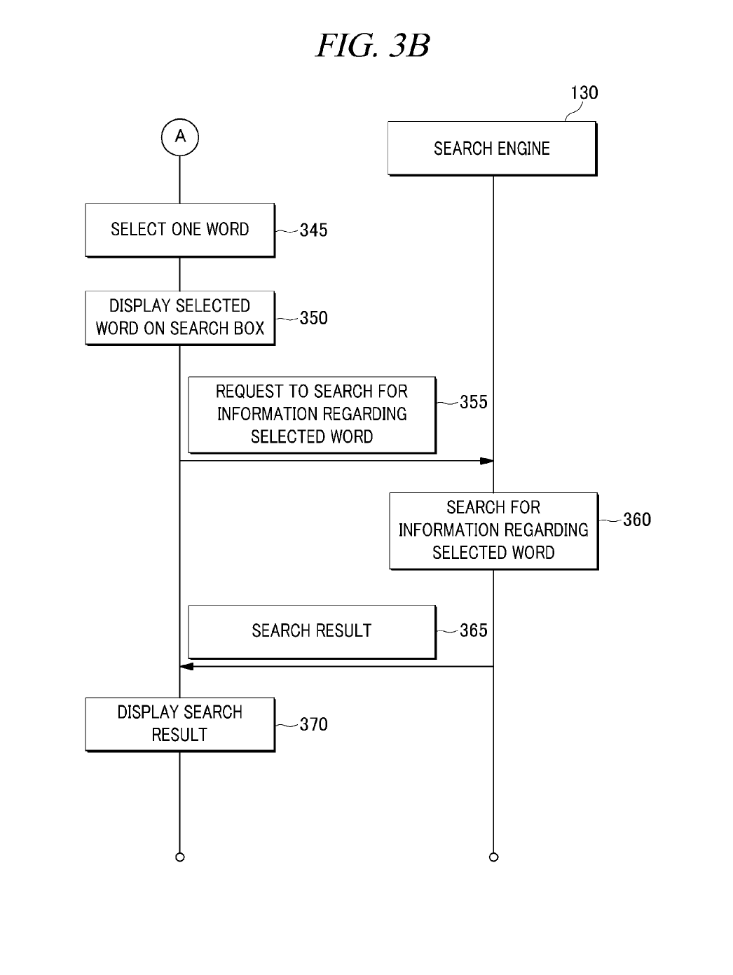

FIGS. 3A and 3B shows an example processing flow of operations to implement at least portions of search by search UI 102, in accordance with embodiments described herein. The process in FIG. 3 may be implemented in system configuration 100 including device 110, content provider 120, search engine 130 and text recognition server 140, as described with reference to FIG. 1. An example process may include one or more operations, actions, or functions as illustrated by one or more blocks 305, 310, 315, 320, 325, 330, 335, 340, 345, 350, 355, 360, 365 and/or 370. Although illustrated as discrete blocks, various blocks may be divided into additional blocks, combined into fewer blocks, or eliminated, depending on the desired implementation. Processing may begin at block 305.

Block 305 (Recognize Words Corresponding to Video Content) may refer to text recognition server 140 recognizing at least one word video content that may be received from content provider 120. For example, with respect to each frame of the video content, text recognition server 140 may be configured to scan the frame, and to recognize or detect a text within the frame. Further, text recognition server 140 may store the at least one recognized word with the frame in a database. Processing may proceed from block 305 to block 310.

Block 310 (Play Video Content) may refer to device 110 playing the video content that may be received from content provider 120. Processing may proceed from block 310 to block 315.

Block 315 (Identify Portion of Video Content) may refer to device 110 receiving a user input, while playing the video content, to select, identify, or highlight at least a portion of the video content at a point in the play time of the video content. Processing may proceed from block 315 to block 320.

Block 320 (Transmit Identified Portion) may refer to device 110 transmitting the selected, identified, or highlighted portion of the video content to text recognition server 140. Processing may proceed from block 320 to block 325.

Block 325 (Retrieve Word) may refer to text recognition server 140 retrieving, from the database of text recognition server 140, a recognized or selected word that is displayed on the video content the selected, identified, or highlighted portion. Processing may proceed from block 325 to block 330.

Block 330 (Transmit Retrieved Word) may refer to text recognition server 140 transmitting the at least one retrieved word to device 110. Processing may proceed from block 330 to block 335.

Block 335 (Transform Retrieved Word into Icon) may refer to device 110 transforming at least one respective icon corresponding to the at least one received word. As referenced herein, the icon may represent a push-button. Further, the icon may be displayed on search UI 102 and be selected by a user input that clicks or touches the icon. Processing may proceed from block 335 to block 340.

Block 340 (Display Received Word as Icon) may refer to device 110 displaying, on search UI 102, the at least one received word as the at least one transformed respective icon. Processing may proceed from block 340 to block 345.

Block 345 (Select One Word) may refer to device 110 receiving a user input to select one of the at least one word displayed on search UI 102. Processing may proceed from block 345 to block 350.

Block 350 (Display Selected Word on Search Box) may refer to device 110 displaying the selected word on search box 104 included in search UI 102. Processing may proceed from block 350 to block 355.

Block 355 (Transmit Request to Search For Information Regarding Selected Word) may refer to device 110 transmitting, to search engine 130, a request to search for information regarding the selected word. Processing may proceed from block 355 to block 360.

Block 360 (Search For Information Regarding Selected Word) may refer to search engine 130 searching the Internet for the information regarding the selected word. Processing may proceed from block 360 to block 365.

Block 365 (Transmit Search Result) may refer to search engine 130 transmitting a search result to device 110. Processing may proceed from block 365 to block 370.

Block 370 (Display Search Result) may refer to device 110 displaying the received search result on search UI 102.

Thus, FIGS. 3A and 3B show an example processing flow of operations to implement at least portions of search by search UI 102, in accordance with embodiments described herein.

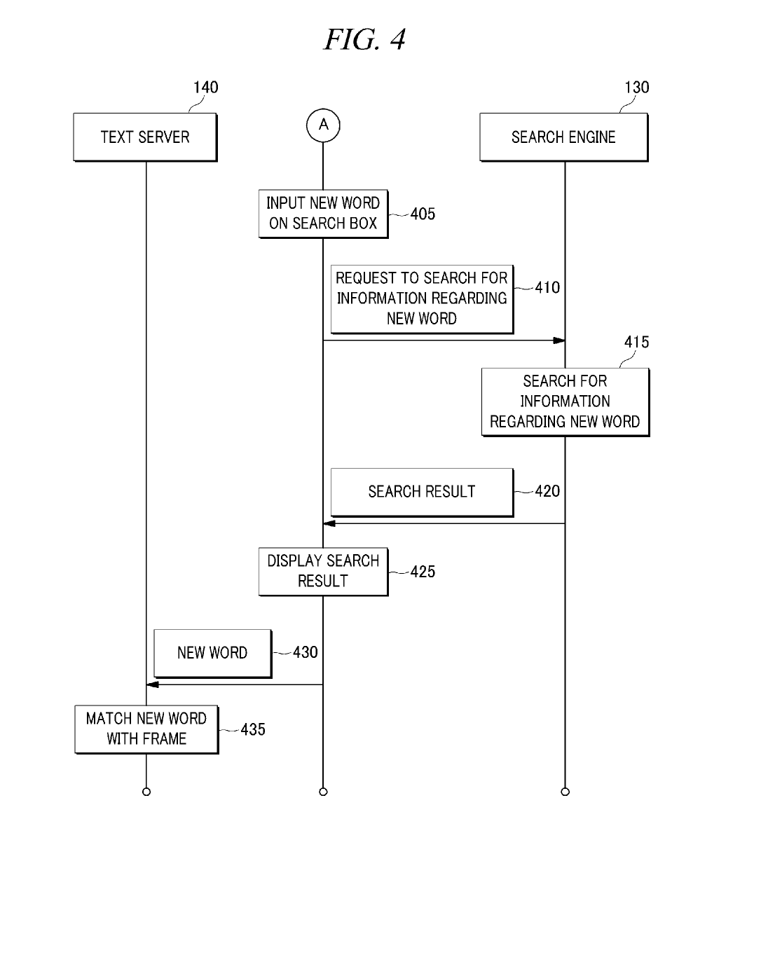

FIG. 4 shows yet another example processing flow of operations to implement at least portions of search by search UI 102, in accordance with embodiments described herein. The process in FIG. 4 may be implemented in system configuration 100 including device 110, content provider 120, search engine 130 and text recognition server 140, as described with reference to FIG. 1. An example process may include one or more operations, actions, or functions as illustrated by one or more blocks 405, 410, 415, 420, 425, 430, and/or 435. Although illustrated as discrete blocks, various blocks may be divided into additional blocks, combined into fewer blocks, or eliminated, depending on the desired implementation. As depicted in FIG. 3A, processing may proceed from block 340 to block 405 if the user want to search for information regarding new word that is not displayed on search UI 102 at block 340.

Block 405 (Input New Word On Search Box) may refer to device 110 receiving a user input to input the new word on search box 104 to request a search for information regarding the newly input word associated with the identified portion of the video content. Processing may proceed from block 405 to block 410.

Block 410 (Transmit Request to Search For Information Regarding New Word) may refer to device 110 transmitting, to search engine 130, a request to search for information regarding the new word. Processing may proceed from block 410 to block 415.

Block 415 (Search For Information Regarding New Word) may refer to search engine 130 searching the Internet for the information regarding the new word. Processing may proceed from block 415 to block 420.

Block 420 (Transmit Search Result) may refer to search engine 130 transmitting a search result to device 110. Processing may proceed from block 420 to block 425.

Block 425 (Display Search Result) may refer to device 110 displaying the received search result on search UI 102. Processing may proceed from block 425 to block 430.

Block 430 (Transmit New Word) may refer to device 110 transmitting the newly input word to text recognition server 140. Processing may proceed from block 430 to block 435.

Block 435 (Match New Word With Frame) may refer to text recognition server 140 matching the newly input word with the frame corresponding to the identified portion of the video content. Thus, when text recognition server 140 receives the identified portion of the video content from device 110 or another device, text recognition server 140 may retrieve and transmit the newly input word in addition to the at least one word displayed on the frame.

Thus, FIG. 4 shows yet another example processing flow of operations to implement at least portions of search by search UI 102, in accordance with embodiments described herein.

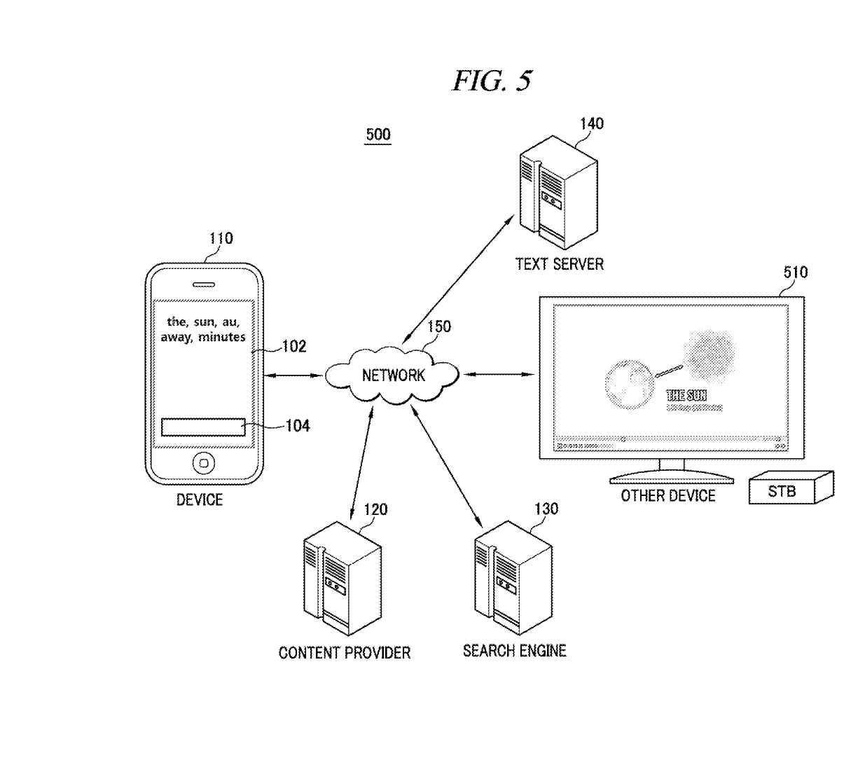

FIG. 5 shows yet another example system configuration 500 in which search UI 102 may be utilized, in accordance with embodiments described herein. As depicted in FIG. 5, system configuration 500 may include, at least, search UI 102 displayed or otherwise hosted on device 110, content provider 120, search engine 130, text recognition server 140 and second device 510; one or more of which may be connected to each other via a wireless network 150.

As depicted in FIG. 5, second device 510 may be configured to play video content received from content provider 120.

By way of examples, second device 510 may refer to at least one of an IPTV (internet protocol television), a DTV (digital television), a smart TV, a connected TV or a STB (set-top box), a mobile phone, a smart phone, a tablet computing device, a notebook computer, a personal computer or a personal communication terminal. Non-limiting examples of such display apparatuses may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

If search UI 102 is overlaid on the video content that is played on second device 510, a part of the video content may be hidden by search UI 102. Further, in this regard, a user input that selects the word displayed on search UI 102 may hide the video content, too. Therefore, because that the video content may be played on second device 510 and search UI 102 may displayed on device 110, device 110 may prevent search UI 102 from hiding the video content.

Thus, FIG. 5 shows yet another example system configuration 500 in which search UI 102 may be utilized, in accordance with embodiments described herein.

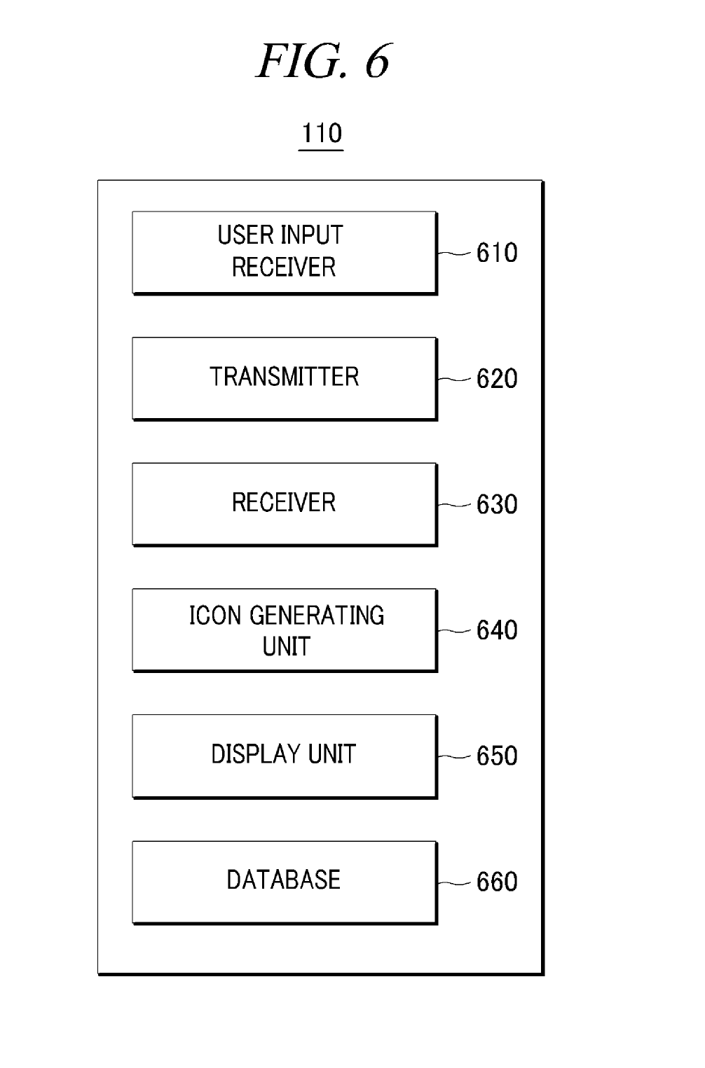

FIG. 6 shows an example configuration of device 110 on which search UI 102 may be utilized, in accordance with embodiments described herein. As depicted in FIG. 6, device 110, first described above with regard to FIG. 1, may include a user input receiver 610, a transmitter 620, a receiver 630, an icon generating unit 640, a display unit 650 and a database 660.

Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of user input receiver 610, transmitter 620, receiver 630, icon generating unit 640, display unit 650 and database 660 may be included in an instance of an application hosted by device 110.

User input receiver 610 may be a component or module that is programmed and/or configured to receive a user input to identify at least a portion of video content at a point in the play time of the video content, by clicking, selecting, or otherwise highlighting the portion of video content. As referenced herein, the video content may be played on at least device 110. For example, the video content may be played on device 110 or another device 510.

Further, user input receiver 610 may be configured to receive a user input to select one of at least one word displayed on search UI 102 to display the selected word on search box 104 included in search UI 102. Then, user input receiver 610 may be configured to receive a user input that clicks, selects, or otherwise highlights search box 104 to request a search for information regarding the selected word displayed on search box 104 from search engine 130.

Alternatively, user input receiver 610 may be further configured to receive a user input to input, onto search box 104, a new word associated with the identified portion of the video content. Then, similarly, user input receiver 610 may receive a user input that clicks, selects, or otherwise highlights search box 104 to request a search for information regarding the newly input word on search box 104 from search engine 130.

Transmitter 620 may be a component or module that is programmed and/or configured to transmit, to text recognition server 140, the identified portion of the video content upon receiving the user input to identify at least the portion of video content.

Transmitter 620 may be further configured to transmit a request to search for information regarding the word displayed on search box 104 upon receiving the user input that clicks, selects, or otherwise activates search box 104.

Further, transmitter 620 may be configured to transmit the newly input word to text recognition server 140 to allow text recognition server 140 to match the newly input word with a frame corresponding to the time point.

Receiver 630 may be a component or module that is programmed and/or configured to receive, from text recognition server 140, at least one word that is detected from the identified portion of the video content.

As referenced herein, the number of the at least one respective word received from text recognition server 140 may be same with the number of at least one respective word shown on the frame corresponding to the identified portion. That is, the at least one respective word received from text recognition server 140 may be matched up with at least one respective word shown on the frame corresponding to the identified portion.

Alternatively, the number of the at least one respective word received from text recognition server 140 may be less than the number of at least one respective word shown on the frame corresponding to the identified portion. For example, at least one word may be omitted from the at least one word shown on the frame at text recognition server 140.

Receiver 630 may be further configured to receive, from search engine 130, a search result regarding the word displayed on search box 104.

Icon generating unit 640 may be a component or module that is programmed and/or configured to generate at least one respective icon corresponding to the at least one word received from text recognition server 140.

Display unit 650 may be a component or module that is programmed and/or configured to display search UI 102 and the at least one word received from text recognition server 140 on search UI 102. As referenced herein, each of the at least one word received from text recognition server 140 may be displayed as the at least one respective generated icon.

Display unit 650 may be further configured to display, on search box 104, the selected word from the at least one word displayed on search UI 102.

Further, display unit 650 may be configured to display the received search result on search UI 102.

Database 660 may be configured to store data, including data input to or output from the components of device 110. Non-limiting examples of such data may include the information regarding the selected word 240 which is received by receiver 640.

Further, by way of example, database 660 may be embodied by at least one of a hard disc drive, a ROM (Read Only Memory), a RAM (Random Access Memory), a flash memory, or a memory card as an internal memory or a detachable memory of device 110.

FIG. 6 shows an example configuration of device 110 on which search UI 102 may be utilized, in accordance with embodiments described herein.

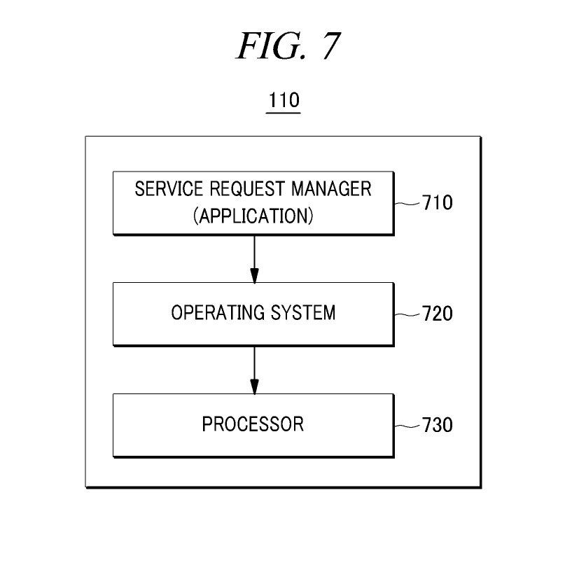

FIG. 7 shows still another example configuration of device 110 on which search UI 102 may be utilized, in accordance with embodiments described herein. As depicted in FIG. 7, device 110, which is described above with regard to FIGS. 1-6, may include a service request manager 710, an operating system 720 and a processor 730.

Service request manager 710 may be an application configured to operate on operating system 720 such that the video content controlling scheme as described herein may be implemented.

Operating system 720 may allow service request manager 710 to manipulate processor 730 to implement the searching scheme using search UI 102 as described herein.

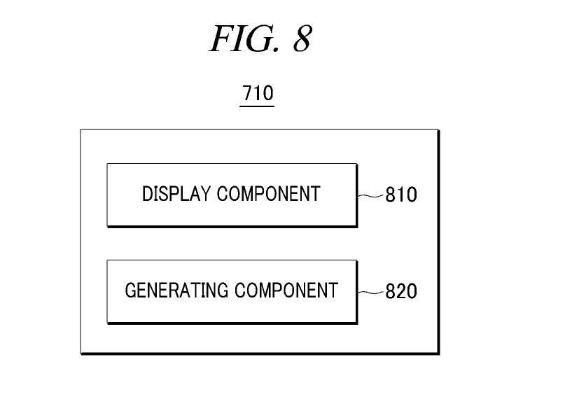

FIG. 8 shows an example configuration of service request manager 710 corresponding to search UI 102, in accordance with embodiments described herein. As depicted, service request manager 710 may include a display component 810 and a generating component 820.

Display component 810 may be configured to display, on search UI 102, at least one word that is received from text recognition server 140. Further, display component 810 may be configured to display, on search box 104, one of the at least one word displayed on search UI 102 that is selected by corresponding user input.

Subsequently, display component 810 may be further configured to display search result regarding the selected word received from search engine 130.

Generating component 820 may be configured to generate at least one respective icon corresponding to the at least one word received from text recognition server 140 to allow the at least one generated icon to be selected by the corresponding user input.

Thus, FIG. 7 shows still another example configuration of device 110 on which search UI 102 may be utilized, and FIG. 8 shows an example configuration of service request manager 710 corresponding to search UI 102, in accordance with embodiments described herein

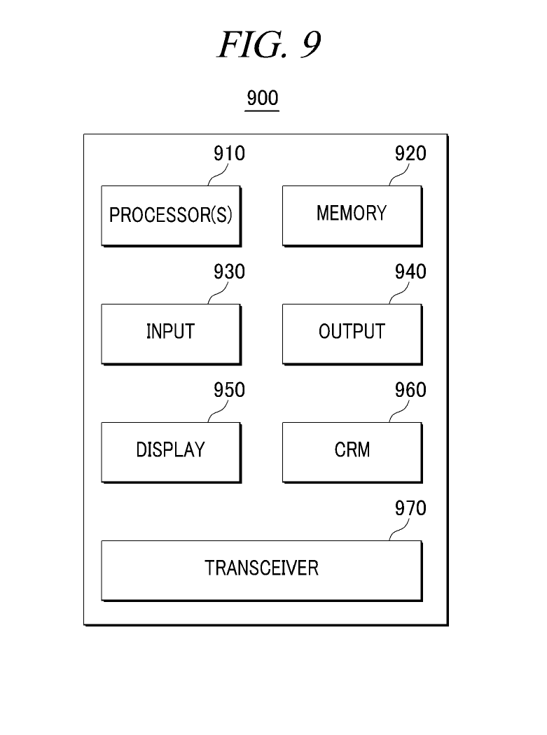

FIG. 9 shows an illustrative computing embodiment, in which any of the processes and sub-processes of a search scheme using search UI 102 displayed on device 110 may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the example system configuration 100 for transactional permissions.

In a very basic configuration, a computing device 900 may typically include, at least, one or more processors 910, a system memory 920, one or more input components 930, one or more output components 940, a display component 950, a computer-readable medium 960, and a transceiver 970.

Processor 910 may refer to, e.g., a microprocessor, a microcontroller, a digital signal processor, or any combination thereof.

Memory 920 may refer to, e.g., a volatile memory, non-volatile memory, or any combination thereof. Memory 920 may store, therein, an operating system, an application, and/or program data. That is, memory 920 may store executable instructions to implement any of the functions or operations described above and, therefore, memory 920 may be regarded as a computer-readable medium.

Input component 930 may refer to a built-in or communicatively coupled keyboard, touch screen, or telecommunication device. Alternatively, input component 930 may include a microphone that is configured, in cooperation with a voice-recognition program that may be stored in memory 930, to receive voice commands from a user of computing device 900. Further, input component 920, if not built-in to computing device 900, may be communicatively coupled thereto via short-range communication protocols including, but not limitation, radio frequency or Bluetooth.

Output component 940 may refer to a component or module, built-in or removable from computing device 900, that is configured to output commands and data to an external device.

Display component 950 may refer to, e.g., a solid state display that may have touch input capabilities. That is, display component 950 may include capabilities that may be shared with or replace those of input component 930.

Computer-readable medium 960 may refer to a separable machine readable medium that is configured to store one or more programs that embody any of the functions or operations described above. That is, computer-readable medium 960, which may be received into or otherwise connected to a drive component of computing device 900, may store executable instructions to implement any of the functions or operations described above. These instructions may be complimentary or otherwise independent of those stored by memory 920.

Transceiver 970 may refer to a network communication link for computing device 900, configured as a wired network or direct-wired connection. Alternatively, transceiver 970 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system comprising:
a device configured to:
receive a first user input to identify at least a portion of video content at a point in a play time of the video content,
transmit the identified portion of the video content to a text server,
receive, from the text server, at least one word that is detected from the identified video content,
display the at least one received word,
receive a second user input to select one of the displayed at least one word, and
transmit a request to search for information regarding the selected word; and
the text recognition server configured to:
receive, from the device, the identified portion of the video content,
retrieve the at least one word displayed on the video content at the point in the play time of the video content, and
transmit, to the device, the at least one word.

2. The system of claim 1, further comprising:
a search engine configured to:
receive, from the device, the request to search for the information regarding the selected word,
search for the information regarding the selected word, and
transmit, to the device, a search result.

3. The system of claim 1, wherein the video content is played on at least one of the device or another device.

4. The system of claim 1, wherein the text recognition server is further configured to recognize the displayed at least one word by utilizing an optical character reader (OCR) method.

5. The system of claim 1, wherein the text recognition server is configured to recognizes the at least one word displayed on the video content by:
scanning a frame corresponding to identified portion of the video content;
detecting a text area within the frame; and
scanning the text area to search for the displayed at least one word.

6. The system of claim 1, wherein the text recognition server is further configured to recognize the displayed at least one word, prior to receiving the identified portion of the video content.

7. The system of claim 1, wherein the text recognition server is further configured to store the displayed at least one word with a frame corresponding to the identified portion of the video content.

8. The system of claim 1, wherein the device is further configured to:
receive a third user input to request a search for information regarding a newly input word associated with the identified portion of the video content; and
transmit the newly input word to the text recognition server, and
wherein the text recognition server is further configured to match the newly input word with a frame corresponding to the identified portion of the video content.

9. The system of claim 8, wherein the text recognition server is further configured to:
receive the identified portion of the video content from another device;
retrieve the newly input word and the displayed at least one word; and
transmit, to the another device, the newly input word and the at least one word.

10. The system of claim 1, wherein the text recognition sever is configured to select at least one word from among the retrieved at least one word, and to transmit the selected at least one word.

11. In connection with a device having a user interface, a method comprising:
receiving a first user input to video content that is played on at least the device;
transmitting, to a text recognition server, an identified portion of the video content at a point in the play time of the video content;
receiving, from the text recognition server, at least one word that is detected from the identified portion of the video content;
displaying the at least one received word;
receiving a second user input to select one of the displayed at least one word; and
transmitting, to a search engine, a request to search for information regarding the selected word.

12. The method of claim 11, wherein the at least one word is displayed in a search box upon receiving the second user input.

13. The method of claim 11, further comprising:
generating at least one icon corresponding to the at least one received word, and
wherein the at least one received word is displayed as the at least one generated icon.

14. The method of claim 11, wherein a number of the at least one received word is less than a number of at least one word displayed on the video content at the point in the play time of the video content.

15. The method of claim 12, further comprising:
receiving a third user input to input, onto the search box, a newly input word associated with the identified portion of the video content;
transmitting, to the search engine, a request to search for information regarding the newly input word; and
transmitting, to the text recognition server, the newly input word.

16. A device comprising:
a user input receiver configured to receive a first user input to identify at least a portion of video content that is played on at least the device;
a transmitter configured to transmit, to a text recognition server, the identified portion of the video content;
a receiver configured to receive, from the text recognition server, at least one word that is detected from the identified portion of the video content; and
a display unit configured to display the at least one received word,
wherein the user input receiver is further configured to receive a second user input to selects one of the displayed at least one word, and
wherein the transmitter is further configured to transmit a request to search for information regarding the selected word.

17. The device of claim 16, wherein the display unit is configured to display the at least one received word in a search box upon receiving the second user input.

18. The device of claim 16, further comprising:
an icon generating unit configured to generate at least one icon from the at least one received word, and
wherein the display unit is further configured to display the at least one received word as the at least one generated icon.

19. The device of claim 16, wherein a number of the at least one received word is less than a number of at least one word displayed in the identified portion of the video content.

20. The device of claim 17, wherein the user input receiver is further configured to receive a third user input to input, onto a search box, a newly input word associated with the identified portion of the video content, and
wherein the transmitter is further configured to transmit, to the search engine, a request to search information regarding the newly input word, and
the transmitter is further configured to transmit, to the text recognition server, the newly input word.
